(19) United States
(12) Patent Application Publication
(10) Pub. No.: US 2002/0125771 A1
(43) Pub. Date: Sep. 12, 2002

(54) Electrical interface device for towing

(76) Inventor: Gary Kaminski, Troy, NY (US)

Correspondence Address: HOVEY, WILLIAMS, TIMMONS & COLLINS, Suite 400, 2405 Grand, Kansas City, MO, 64108, US

(21) Appl. No.: 09/800,342

(22) Filed: Mar. 6, 2001

(51) Int. Cl. B60L 1/00

(52) U.S. Cl. 307/10.1

(57) ABSTRACT

An electrical interface device (10) for towing, operable to facilitate releasably coupling one or more electrical subsystems of a towing vehicle (12) and a towed vehicle, and including associated modular, removable circuitry (24). The circuitry (24) may provide overload, short-circuit, and reverse connection protection and power signal filtering. Alternative or additional circuitry may be added to support other functionality, including interfacing a brake control subsystem. Circular receptacle and flat plug connectors (20,22) are provided to accommodate without modification a variety of electrical connectors. Covers (32,33) are also provided to protect unused connectors from adverse environmental conditions.

### RELATED APPLICATIONS

The subject matter of the present application is related to the subject matter of non-provisional application titled “Towing Connector”, Ser. No. 09/695,268, filed Oct. 24, 2000, and the subject matter of non-provisional application titled “A Short-Proof Power Conversion and Isolation Device for Electrically Coupling Towing and Towed Vehicles”, Ser. No. 09/678,012, filed Oct. 3, 2000, both of which are hereby incorporated into the present application by reference.

### BACKGROUND OF THE INVENTION

1. Field of the Invention

The present invention relates to electrical interface devices for facilitating electrical connection between electrical systems and subsystems of towing vehicles and towed vehicles. More particularly, the invention concerns an electrical interface device incorporating modular, removable circuitry, such as shortproof power conversion and isolation circuitry, and operable to couple one or more electrical subsystems, such as a signaling or brake control subsystem, of a towing vehicle with that of a towed vehicle. The electrical interface is further operable to accommodate a variety of common harness connectors safely and without modification.

2. Description of the Prior Art

In recent years, rising popularity of outdoor recreational activities, such as boating and camping, has led to an increase in use of trailers, campers, boats and other towed vehicles. These towed vehicles typically include signaling, brake control, or other electrical subsystems designed to be coupled with corresponding subsystems or controls on a towing vehicle. Many state and federal laws, for example, require that towed vehicles have an on-board signaling subsystem for providing brake lights, turn signals, and other driving safety features. This onboard subsystem is typically slaved to a master signaling subsystem of a towing vehicle to activate appropriate signals on the towed vehicle so that, for example, when brake lights, turn signals, or backup lights on the towing vehicle are energized, corresponding brake lights, turn signals, or backup lights on the towed vehicle are simultaneously energized. Typically, each vehicle's signaling subsystem includes a wiring harness comprising electrical wiring and terminating in a harness connector having male or female terminals in a pin or blade configuration operable to establish a releasable hard-wired electrical connection.

Early wiring harnesses included relatively simple flat harness connectors having four terminals arranged in a spaced, linear arrangement. These early connectors were sufficient for handling low current requirements of simple electrical subsystems. However, with proliferation of ever more sophisticated vehicle electronics, harness connectors having six or seven wires are increasingly common on both towing and towed vehicles. Furthermore, such modern harness connectors are often circularly shaped with concentrically arranged terminals in order to practically accommodate additional terminals required for the increased number of wires.

Existing electrical interface devices typically present either a round or a flat receptacle or plug (but not both) for receiving the towing vehicle's harness connector. An existing device, for example, presents a circular connector in the form of an appropriately configured socket-type receptacle which, while suitable for use with towed vehicles having such circular harness connectors, does not provide for older flat connectors without modification. Thus, when a towed vehicle presents a flat rather than round harness connector, it is necessary to bypass the interface device and directly couple the two subsystems. This is not only troublesome, but also results in a condition whereby the coupled connectors are in a suspended, exposed position where separation of or damage to the connectors is more likely to occur.

Furthermore, existing harness connectors typically fail to protect against overload and short-circuit conditions that could damage the electronics of both vehicles, including the connection circuit itself. Resulting increased current load and feedback may damage sensitive microcontrollers or other electrical components in either or both vehicles. Some circuits also fail to mitigate the effects of switching noise which could cause the signaling lights to flicker. Additionally, many existing circuits fail to provide protection against reverse power connection. Thus, if the power and ground connections are accidently reversed, sensitive circuit components may be critically damaged.

Additionally, many existing interface devices do not provide adequate electrical isolation between the two vehicles, resulting in current being drawn directly from the towing vehicle's signaling subsystem, which can cause power drains, interference, and surges that interfere with both the signaling lights and associated sensing circuitry providing input to dashboard indicators. One well-known solution to this lack of electrical isolation is to equip the towing vehicle with a parallel second harness whose only purpose is to couple with the towed vehicles harness. The towing vehicle's signaling subsystem, being connected to a first harness, is physically isolated from the towed vehicles subsystem.

With regard to brake controller and other electrical subsystems, operators are typically required to purchase or fashion and mount a number of independent, non-integrated interface devices and connectors for coupling the towed vehicle's subsystems to those of the towing vehicle. This results in increased cost, as no common components are shared, as well as compatibility and upgrade problems.

Due to the identified and other problems in the art, an improved electrical harness connector or interface is needed.

### SUMMARY OF THE INVENTION

The present invention overcomes the above identified and other problems and provides a distinct advance in the art of electrical interface devices for towing applications. Specifically, the present invention provides an improved interface device operable to facilitate releasably coupling and slaving an electrical subsystem of a towed vehicle to a master electrical subsystem. Furthermore, the interface device has expandable functionality in that multi-system interface capability, including signaling, brake control, and other subsystems, is integrated into a single package by means of modular, removeable components.

The interface device comprises a body, circular receptacle and flat plug connectors, modular circuitry, and an electrical lead assembly. In order to provide all-weather protection, the body includes hingedly-mounted, individually operable covers corresponding to the circular and flat connectors.

The circular and flat alternative connectors are each operable to receive a corresponding complemental harness connector forming a part of the electrical subsystem of the towed vehicle. Thus, the interface device is able, without modification, to accommodate a variety of common connectors. Each connector presents a plurality of male or female pin- or blade-type electrical terminals.

With regard to signaling subsystems, modularly removable power conversion and isolation circuitry is provided to protect all outputs from overload such that when the circuit's drivers are loaded in excess of 8.5A, they will switch off and cycle on-off until the overload condition is corrected. The circuitry also protects all outputs from short-circuiting such that when a wire shorts to ground the output is latched off when the short condition exceeds 30A. Furthermore, the circuitry uses CMOS XOR logic gates which restricts feedback damage to the towing vehicle and provides a high degree of electrical isolation between the towing and towed vehicles. The circuitry also incorporates a filter to mitigate switching noise which might otherwise cause the signaling lights to flicker. Furthermore, the power conversion and isolation circuitry includes a power feature allowing tail light and auxiliary lines to be combined in order to double the normal 8.4A driver output to 16A on the tail light circuit.

With regard to brake controllers and other subsystems, modular circuitry is provided that can be easily added and removed depending upon desired functionality. Additional advantages include easier upgrades and repairs.

The electrical lead assembly is electrically connected with input terminals of the power conversion and isolation circuitry, and has a plurality of leads releasably connectable to the electrical subsystem of the towing vehicle. The lead assembly and input terminals are connected such that a complemental towed vehicle electrical connector coupled to either of the connectors will operatively interconnect the signaling subsystems of the towing and towed vehicles.

These and other features are explained in greater detail in the section below entitled DETAILED DESCRIPTION OF A PREFERRED EMBODIMENT.

### BRIEF DESCRIPTION OF THE DRAWINGS

A preferred embodiment of the present invention is described in detail below with reference to the attached drawing figures, wherein:

FIG. 1 is a fragmentary isometric view of a preferred embodiment of the electrical interface device of the present invention mounted upon a rear bumper of a towing vehicle;

FIG. 2 is an exploded perspective view showing in detail components of a preferred embodiment of the electrical interface device of the present invention;

FIG. 3 is a front elevational view of the embodiment shown in FIG. 1, wherein first and second covers are raised to more clearly show the structure of circular and flat connectors;

FIG. 4 is a circuit schematic illustrating a preferred embodiment of the power conversion and isolation circuitry component of the present invention; and

FIG. 5 is an isometric view of the embodiment of FIG. 2 wherein the components have been assembled.

The drawing figures do not limit the present invention to the specific embodiments disclosed and described herein. The drawings are not necessarily to scale, emphasis being placed upon clearly illustrating the principles of the invention.

### DETAILED DESCRIPTION OF A PREFERRED EMBODIMENT

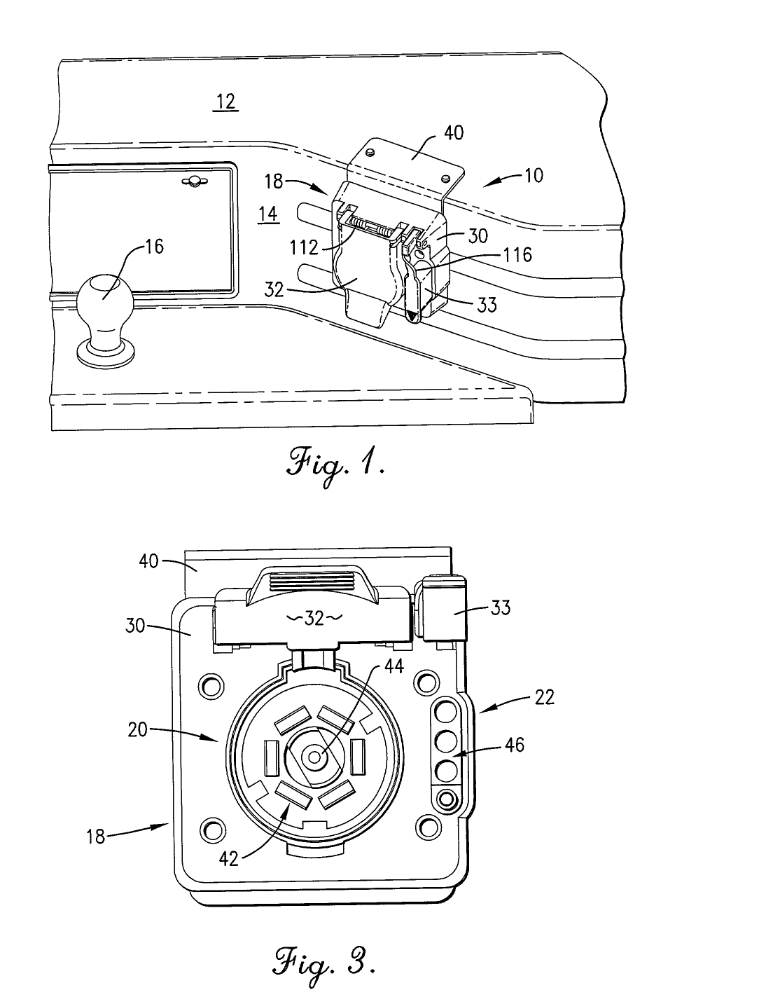

Referring to FIG. 1, an electrical interface device 10 is shown constructed in accordance with a preferred embodiment of the present invention and operable to electrically interconnect two vehicular electrical subsystems, as, for example, those of a towing vehicle 12, such as a car or truck, and a towed vehicle (not shown), such as a boat trailer or travel trailer. In FIG. 1, the device 10 is shown mounted upon a rear bumper portion 14 of the towing vehicle 12, with the bumper 14 being equipped with a conventional towing hitch 16. The device 10 is not limited, however, to the illustrated mounting location or scheme, and, instead, may be mounted in any suitable location using any suitable mechanism.

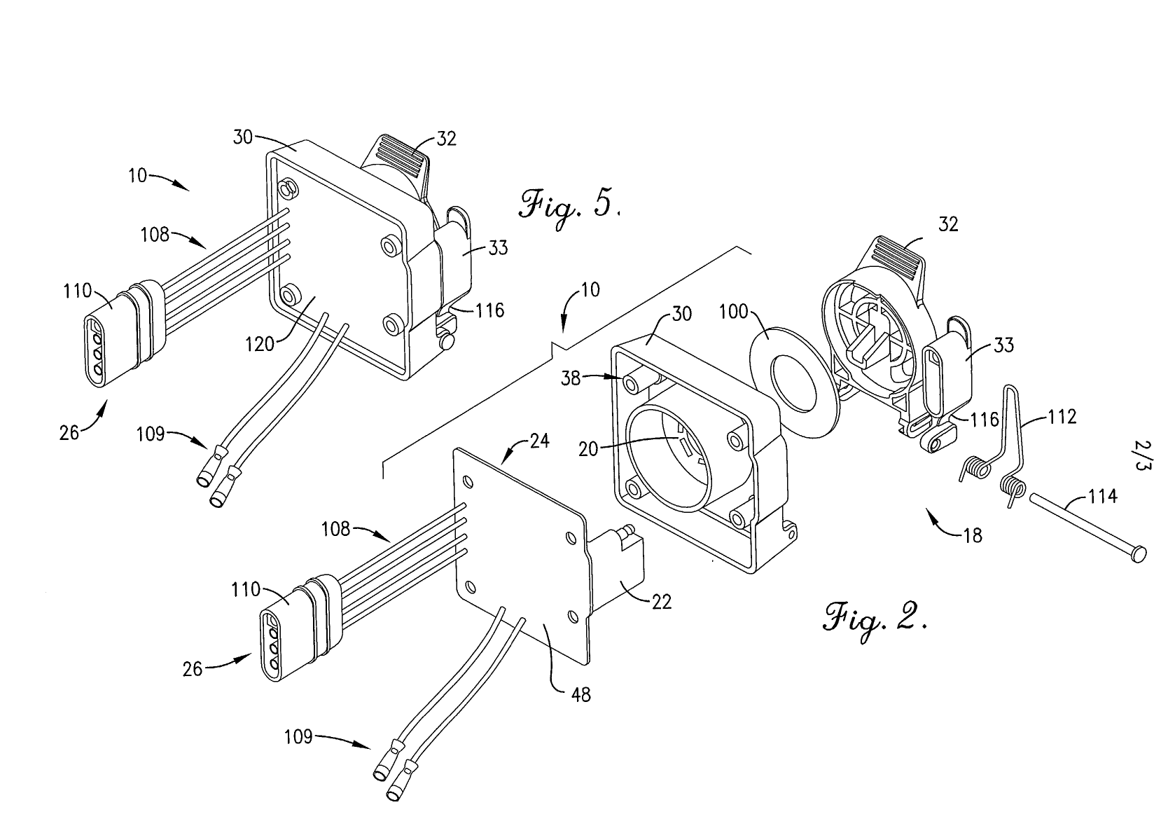

Referring also to FIG. 2, the preferred electrical interface 10 broadly comprises a body 18; circular receptacle and flat plug connectors 20,22; power conversion and isolation circuitry 24; and an electrical lead assembly 26. The body 18 provides structure for supporting and protecting other device components and for mounting the device 10 upon the towing vehicle 12. The body 18 comprises a housing 30 and first and second covers 32,33. Body portions, unless otherwise noted, are formed of a synthetic resin or similarly suitable lightweight, durable, and weatherproof material.

The housing 30 is open to the rear, and further comprises four rearwardly extending annular screw-receiving bosses 38 operable to securely couple the housing 30 with the power conversion and isolation circuitry 24, as is described below.

The first and second covers 32,33, corresponding to the circular and flat connectors 20,22, respectively, are independently operable to provide all-weather protection while allowing easy access to the connectors 20,22. The first cover 32 is hingedly mounted upon and biased against the housing 30 by a hinge pin 112 and spring 114. A resilient elastomeric sealing ring 100 is affixed to an inner surface of the circular receptacle 20 to provide a weatherproof seal. The second cover 33 is hingedly mounted upon the housing 30 by the hinge pin 112 and a flexible tail 116.

The body 18 may also include a mounting bracket 40 for securing the device to a vehicle surface (see FIG. 1). The bracket 40 is preferably a generally L-shaped metal mounting bracket secured by one leg with screws to the housing 30 and by another leg with screws to the surface or structure of the towing vehicle 12, such as under, on, or over the rear bumper 14.

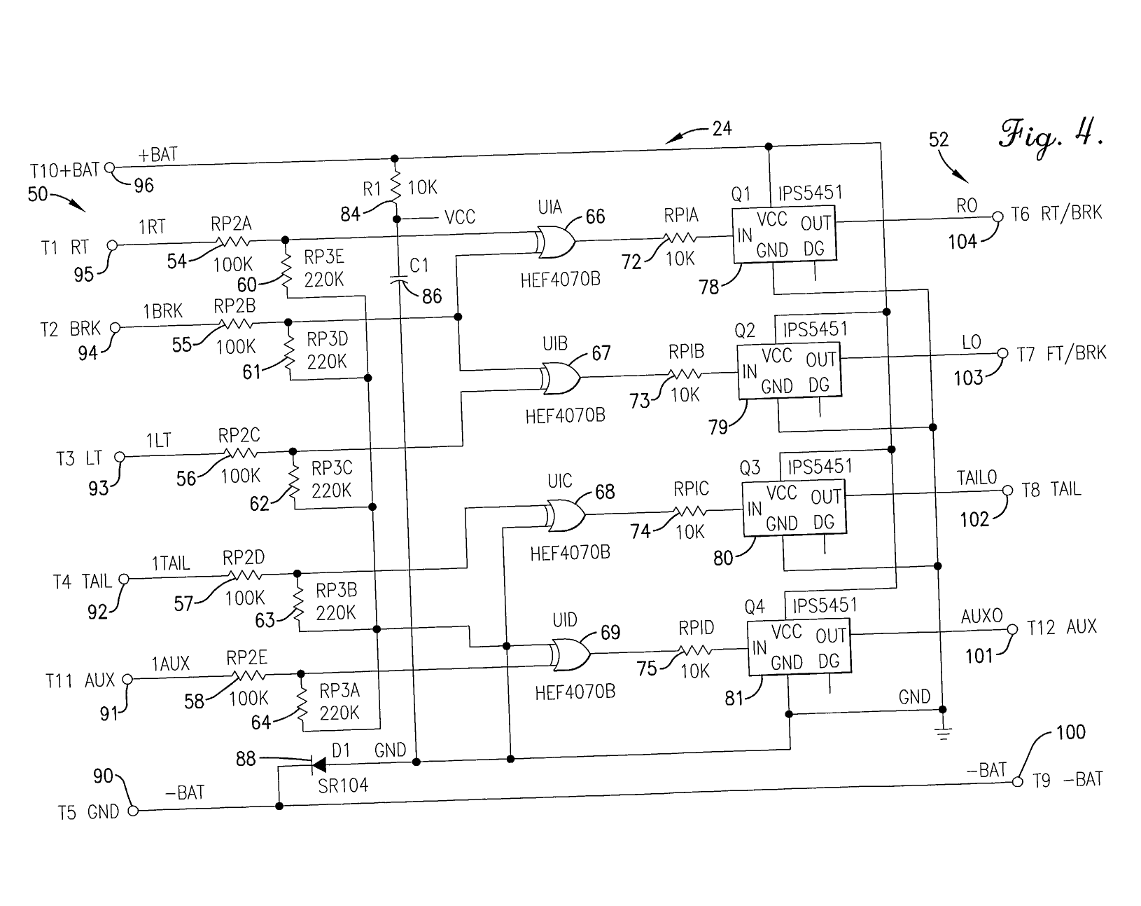

Referring also to FIGS. 3 and 4, the circular receptacle and flat plug connectors 20,22 provide independently operable alternative electrical connection mechanisms for coupling with the towed vehicle's harness connector. The circular receptacle 20 presents a plurality of terminals 42, preferably six, concentrically arranged about a single central terminal 44. Terminal type, whether male, female, pin, or blade, and number may vary depending on design and contemplated use. In one embodiment, all of the outer terminals 42 are male and blade-type, and the center terminal 44 is female and pin- or socket-type. The terminals 42,44 are electrically hard-wired to trailer output connections 16 of the power conversion and isolation circuitry 24, as is described below. In one embodiment, the terminals 42,44 may be soldered directly to a printed circuit board 48 (described below) component of the circuitry 24.

The flat plug 22 presents a plurality of terminals 46, preferably four, linearly arranged. Terminal type, whether male, female, pin, or blade, and number may vary depending on design. In one embodiment, all terminals 46 are pin type, with three being female and the fourth being male. The terminals 46 are electrically hard-wired to trailer output connections 16 of the power conversion and isolation circuitry 24, as is described below.

Referring also to FIG. 4, the power conversion and isolation circuitry 24 provides five-to-four and four-to-three conversion with either positive or negative signal input, and a four-to-four isolator, also having either positive or negative signal input, for towed vehicles with separate brake and turn signals. The circuitry 24 is protectively located within the body housing 30, and securable with screws to the screw-receiving bosses 38.

The circuitry 24 broadly comprises a printed circuit board (POB) 48; vehicle input connections 50; trailer output connections 52; a 100K isolated resistor network 54,55,56,57,58; a 220K bussed resistor network 60,61,62,63,64: four XOR gates 66,67,68,69; a 10K isolated resistor network 72,73,74,75; four MOSFET drivers 78,79,80,81; a filter resistor 84; a filter capacitor 86; and a protection diode 88. All components are commonly available. The PCB 48 provides a suitable mounting surface for other circuitry components, and provides structure that allows the circuitry 24 to be secured to the housing 30 by screws. The PCB 34 may be reinforced as desired to withstand connection forces associated with coupling the towed vehicle's harness connector to the interface device's circular or flat connector 20,22.

The power conversion and isolation circuitry 24 may be easily added to or removed from the interface device 10 for upgrading, repair, or where its functionality is not needed. Furthermore, additional modular circuitry (not shown), corresponding to a brake control or other electrical subsystem, may be added to or removed from the interface device 10 depending upon desired functionality. Multiple circuitries may be simultaneously incorporated into the interface device as needed.

The vehicle input connections 50 provide input connection points for electrical signal controlling activation of the towing vehicle's rear lights and signals. The vehicle input connections 50 are electrically hard-wired to the lead assembly 20. The vehicle input connections 50 include a ground connection 90; an auxiliary/backup light connection 91; a tail light connection 92; a left turn signal connection 93; a right turn signal connection 94; a brake light connection 95; and a battery connection 96. The ground connection 90 provides a common electrical ground for both signaling subsystems. The aux./backup light connection 91 provides a connection point for either an auxiliary power signal or a reverse or “back-up” light signal. The tail light connection 92 provides a connection point for a tail light signal. The left turn and right turn signal connections 93,95 provide connection points for left and right turn signals, respectively. The brake light connection 94 provides a connection point for a brake light signal. The battery connection 96 provides a connection point for a power signal from the towing vehicle's battery or other power source.

The trailer output connection points 52 provide output connection points for electrical signals to control activation of the towed vehicle's lights signals. The trailer output connections 52 are electrically hard-wired to the terminals 42,44,46 of the circular and flat connectors 20,22. The trailer output connections 52 include a ground connection 100; an auxiliary/backup light connection 101; a tail light connection 102; a left turn/brake connection 103; and a right turn/brake connection 104. The ground connection 100 provides a common electrical ground for the two signaling subsystems. The aux./backup light connection 101 provides a connection point for an auxiliary power signal or a reverse or “back-up” light signal. The tail light connection 102 provides a connection point for a tail light signal. The left turn/brake and right turn/brake signal connections 103,104 provide connection points for left and right turn/brake signals, respectively.

The 100K isolated resistor network 54,55,56,57,58 is included for current limiting purposes. The 220K bussed resistor network 60,61,62,63.64 is included to pull-up or pull-down floating lines resulting from burned out signal bulbs.

The four XOR gates 66,67,68,69 provide logic to interpret input from the towing vehicle's signaling subsystem, and provide electrical isolation between the input and output signals. The four XOR gates 66,67,68,69 are preferably present in a single, commonly available chip having four (quad) two input CMOS XOR gates. When multiple inputs are received, the XOR gates determine the correct combined response to appear on the towed vehicle's signaling system. This is necessary because separate towing vehicle turn and brake signaling lights may, in the towed vehicle, appear as turn/brake combination lights. For example, a brake input by itself results in steady activation of both of the towed vehicle's turn/brake signals 103,104; and a right turn input by itself results in flashing activation of the right turn/brake signal 104. However, combined right turn 195 and brake 94 inputs result in flashing activation of the towed vehicle's right turn/brake signal 104 and steady activation of the left turn/brake signal 103.

The 10K isolated resistor network 72,73,74,75 is included to limit current to approximately 1 mA flowing to the MOSFET drivers 78,79,80,81 from the XOR gates 66,67,68,69.

Each MOSFET driver 78,79,80,81 receives input from the XOR gates 66,67,68,69 and drives an output to the trailer output connections 52. Each driver 78,79,80,81 receives power and ground from the battery and ground connections 96,90, respectively, of the vehicle input connections 50. The drivers 78,79,80,81 are preferably fully-protected five terminal high side switches with built-in short-circuit, over-current, over-temperature, electro-static discharge (ESD) protection, inductive load capability and diagnostic feedback. When a short-circuit, current-overload, or other dangerous stop condition occurs, the preferred drivers 78,79,80,81 stop providing output until the condition is remedied, at which time output automatically resumes. Suitable shortproof and overload protected MOSFET switches are available from various vendors, including, for example, the IPS5451/IPS5451S MOSFET switches available from International Rectifier.

The preferred circuitry 24 provides 8.4A per MOSFET driver at 13.4 VDC. Standby current consumption to the circuit is 100 uA or less. Input current from the towing vehicle 12 required to actuate each driver is 10 to 20 uA at 12 to 13.5 VDC. Furthermore, all outputs 52 are overload protected such that when the circuit's drivers are loaded in excess of 8.5A, they will turn off and cycle on-off until the overload condition is corrected. All outputs 52 are also short-circuit protected so that when a trailer wire shorts to ground the output is latched off when the short condition exceeds 30A.

The circuitry 24 includes a power feature allowing the auxiliary and tail light inputs 91,92 to be combined in order to double the normal 8.4A per driver output to 16A on the tail light circuit 102.

The filter resistor 84 and filter capacitor 86 combine to form a filter for mitigating electronic noise that might otherwise cause the signal lights to flicker. Preferably, the resistor 84 is a 10K resistor with a power rating of 1/4W and a tolerance of 5%; and the capacitor 86 is a 0.1 uF ceramic capacitor. The protection diode 88 is preferably a Schottky barrier diode that provides reverse power connection protection in the event that power is applied to the ground connection 90 and ground is applied to the battery connection 96. Without the diode 88, current flowing in the wrong direction due to reverse power connection would likely damage the XOR gates 66,67,68,69.

The lead assembly 20 facilitates coupling the towing vehicle's signaling subsystem with the interface device 10, and comprises a plurality of input wires 108 and power and ground wires 109. The input wires 108 are connected at respective first ends to corresponding vehicle input terminals 50 of the power conversion and isolation circuitry 24, and at respective second ends with a flat electrical coupler 110 operable to releasably couple with the towing vehicle's harness connector. The power and ground wires 109 couple at their respective first ends with corresponding vehicle input terminals 50, and at their respective second ends with individual electrical connectors operable to couple with power and ground connections presented by the towing vehicle 12.

Where the interface device, through use of modular circuitry, is able to accommodate a number of electrical subsystems, such as a brake control subsystem, the lead assembly 20 will include corresponding input wires as needed. Only one power and one ground wire 108,109 are required, however, as these inputs may be shared.

Referring also to FIG. 5, once the interface device 10 is assembled, a liquid or molten sealing or potting compound may be poured or otherwise introduced into the housing 30 to harden and protect the circuitry 24 and electrical connections from exposure and damage. The sealing or potting compound is not required and may be replaced with a weathertight removable cover or other suitable protective structure, particularly where it is desired to allow periodic access to the housing interior so that modular circuitry, such as the power conversion and isolation circuitry 24, may be removed or added as desired.

In operation, the interface device 10 is first mounted and secured in place on a towing vehicle 12, by means of the bracket 40 and appropriate fasteners, at a convenient location, such as on, over, or under the bumper 14. Next, the device 10 is connected to the electrical subsystem of the towing vehicle 12 by connecting the flat electrical coupler 110 with a harness connector presented by the towing vehicle 12, and the power and ground wires 110 with corresponding connectors also presented by the towing vehicle.

Thereafter, when it is desired to tow a vehicle with a circular harness connector, the interface device's first cover 32 is lifted and the towed vehicle's harness connector is plugged into the circular socket 34 to engage the terminals 42,44 of the circular receptacle 20. Alternatively, when it is desired to tow a vehicle with a flat harness connector, the interface device's second cover 33 is removed and the towed vehicle's harness connector is connected to engage the terminals 46 of the flat plug 22. In either case, connection in this manner serves to properly electrically interconnect the electrical subsystems of the two vehicles without any modification of the interface device 10.

Although the invention has been described with reference to the preferred embodiment illustrated in the attached drawing figures, it is noted that equivalents may be employed and substitutions made herein without departing from the scope of the invention as recited in the claims. For example, as noted, the described power conversion and isolation circuitry 24 is but one modular, removable circuitry that may be selectively incorporated into the interface device 10. Other modular circuitries may concern brake control or other electrical subsystems where it is desirable to provide an electrical interface and associated circuitry between the towing and towed vehicles. Thus, it will also be appreciated that the exact nature, design, shape, and number and type of terminals of the connectors 20,22 may vary as matters of design and contemplated application as well.

Having thus described the preferred embodiment of the invention, what is claimed as new and desired to be protected by Letters Patent includes the following:

1. An electrical interface device for connecting one or more master electrical subsystems of a towing vehicle to one or more slave electrical subsystems of a towed vehicle, with each slave electrical subsystem including a harness connector, the electrical interface device comprising:
a body for mounting on the towing vehicle;
a first master connector incorporated into the body and operable to detachably couple with a first type of harness connector; and
one or more modular circuits removably mountable within the body, wherein each modular circuit corresponds to a different slave electrical subsystem.

2. The electrical interface device as set forth in claim 1, wherein the one or more modular circuits includes a power conversion and isolation circuit corresponding to a signaling subsystem.

3. The electrical interface device as set forth in claim 1, wherein the one or more modular circuits includes a brake control circuit corresponding to an electric brake control subsystem.

4. The electrical interface device as set forth in claim 1, further including a second master connector incorporated into the body and operable to detachably couple with a second type harness connector.

5. An electrical interface device for connecting a master electrical subsystem of a towing vehicle to a slave electrical subsystem of a towed vehicle, with the slave electrical subsystem including one of a plurality of different types of harness connectors, the electrical interface device comprising:
a body for mounting on the towing vehicle;
a first master connector incorporated into the body and operable to detachably couple with a first type of the plurality of different types of harness connectors;
a second master connector incorporated into the body and operable to detachably couple with a second type of the plurality of different types of harness connectors; and
a circuit comprising—
an input connection operable to couple the circuit with the master electrical subsystem and to receive an input signal therefrom,
a driver circuit operable to receive the input signal and provide an output signal having an output current, the driver being further operable to stop providing the output signal when the output current exceeds a pre-established maximum value, and
an output connection operable to couple the circuit with the first and second master connectors.

6. The electrical interface device as set forth in claim 5, wherein the first master connector comprises a circular receptacle presenting at least one electrical terminal, with the electrical terminal being operatively coupled with the output connection.

7. The electrical interface device as set forth in claim 5, wherein the second master connector comprises a flat plug presenting at least one electrical terminal, with the electrical terminal being operatively coupled with the output connection.

8. The electrical interface device as set forth in claim 5, wherein the driver circuit includes a power metal oxide semiconductor field effect transistor

9. The electrical interface device as set forth in claim 5, further comprising a first cover and a second cover secured to the body and operable to selectively cover the first and second master connectors, respectively.

10. The electrical interface device as setforth in claim 5, wherein the circuit further comprises:
a power connection operable to couple the circuit with a power supply;
a ground connection operable to couple the circuit with an electrical ground; and
a diode coupled with the ground connection and operable to restrict current flowing from the ground connection to the circuit.

11. The electrical interface device as set forth in claim 10, wherein the circuit further comprises a filter coupled with the power supply connection and operable to mitigate electrical noise in a power supply signal.

12. An electrical interface device for connecting a master electrical subsystem of a towing vehicle to a slave electrical subsystem of a towed vehicle, with the slave electrical subsystem including one of a plurality of different types of harness connectors, the electrical interface device comprising:
a body for mounting on the towing vehicle;
a first master connector incorporated into the body and operable to detachably couple with a first type of the plurality of different types of harness connectors;
a second master connector incorporated into the body and operable to detachably couple with a second type of the plurality of different types of harness connectors; and
a circuit comprising—
a plurality of input connections operable to couple the circuit with the master electrical subsystem, with each input connection being operable to receive an input signal,
at least one interpreter circuit coupled with two or more of the input connections and operable to generate an output signal based upon the input signals received, and further operable to electrically isolate the input signals from the output signal, and
an output connection operable to couple the circuit with the first and second master connectors.

13. The electrical interface device as set forth in claim 12, wherein the first master connector comprises a circular receptacle presenting at least one electrical terminal, with the electrical terminal being operatively coupled with the output connection.

14. The electrical interface device as set forth in claim 12, wherein the second master connector comprises a flat plug presenting at least one electrical terminal, with the electrical terminal being operatively coupled with the output connection.

15. The electrical interface device as set forth in claim 12, wherein the interpreter circuit includes an XOR logic gate.

16. The electrical interface device as set forth in claim 12, further comprising a first cover and a second cover secured to the body and operable to selectively cover the first and second master connectors, respectively.

17. The electrical interface device as set forth in claim 12, wherein the circuit further comprises:
a power connection operable to couple the circuit with a power supply;
a ground connection operable to couple the circuit with an electrical ground; and
a diode coupled with the ground connection and operable to restrict current from flowing from the ground connection to the circuit.

18. The electrical interface device as set forth in claim 17, wherein the circuit further comprises a filter coupled with the power supply connection and operable to mitigate electrical noise in a power supply signal.

19. An electrical interface device for connecting a master electrical subsystem of a towing vehicle to a slave electrical subsystem of a towed vehicle, with the slave electrical subsystem including one of a plurality of different types of harness connectors, the electrical interface device comprising:
a body for mounting on the towing vehicle;
a first master connector incorporated into the body and operable to detachably couple with a first type of the plurality of different types of harness connectors;
a second master connector incorporated into the body and operable to detachably couple with a second type of the plurality of different types of harness connectors; and
a circuit comprising—
power connection operable to couple the circuit with a power supply,
a ground connection operable to couple the circuit with an electrical ground,
a reverse current protector coupled with the ground connection and operable to restrict a current from flowing from the ground connection to the circuit,
a plurality of input connections operable to couple the circuit with the master electrical subsystem, with each input connection being operable to receive an input signal,
at least one interpreter circuit coupled with two or more of the plurality of input connections and operable to generate an intermediate output signal based upon the input signals received, and further operable to electrically isolate the input signals from the intermediate output signal, and
at least one driver circuit operable to receive at least one of the intermediate output signals and provide an output signal having an output current, the driver being further operable to stop providing the output signal when the output current exceeds a pre-established maximum value.
an output connection operable to couple the circuit with the first and second master connectors.

20. The electrical interface device as set forth in claim 19, wherein the first master connector comprises a circular receptacle presenting at least one electrical terminal, with the electrical terminal being operatively coupled with the output connection.

21. The electrical interface device as set forth in claim 19, wherein the second master connector comprises a flat plug presenting at least one electrical terminal, with the electrical terminal being operatively coupled with the output connection.

22. The electrical interface as set forth in claim 19, wherein the plurality of input connections include a brake light input connection, a left turn signal input connection, a right turn signal input connection, and a tail light input connection, with each input connection being operable to receive an input signal corresponding to a particular signaling light of the master electrical subsystem.

23. The electrical interface as set forth in claim 19, wherein the plurality of output connections include a right turn/brake light output connection, a left turn/brake light output connection, and a tail light output connection, with each output connection corresponding to one or more signaling lights of the slave electrical subsystem.

24. The electrical interface device as set forth in claim 19, wherein the interpreter circuit includes an XOR logic gate.

25. The electrical interface device as set forth in claim 19, wherein the driver circuit includes a power metal oxide semiconductor field effect transistor.

26. The electrical interface device as set forth in claim 19, wherein the number of interpreter circuits, the number of driver circuits, and the number of output connections are equal.

27. The electrical interface device as set forth in claim 19, wherein the reverse current protector includes a diode.

28. The electrical interface device as set forth in claim 19, wherein the driver circuits number at least two and at least two of the driver circuits are interconnectable so as to produce a combined output signal having an output current equal to the combined output currents of the individual driver circuits.

29. The electrical interface device as set forth in claim 19, further comprising a filter coupled with the power supply connection and operable to mitigate electrical noise in a power supply signal.

30. The electrical interface device as set forth in claim 19, further comprising a first cover and a second cover secured to the body and operable to selectively cover the first and second master connectors, respectively.
